(19) United States
(12) Patent Application Publication
(10) Pub. No.: US 2026/0366942 A1
(43) Pub. Date: Nov. 19, 2026

(54) METHOD FOR DETERMINING THE MAINTENANCE STATE OF A TENSILE FORCE MEASURING DEVICE FOR AN AGRICULTURAL TRACTOR

(71) Applicant: DEERE & COMPANY, MOLINE, IL (US)

(72) Inventor: Lucas Alexander Schreieck, Rhineland (DE)

(21) Appl. No.: 19/551,857

(22) Filed: Feb. 27, 2026

(30) Foreign Application Priority Data
May 19, 2025 (EP) 25177259.6

(51) Int. Cl. G01L 25/00; G01L 5/00

(52) U.S. Cl. CPC G01L 25/00; G01L 5/0033

(57) ABSTRACT

A method for determining a maintenance state of a tensile force measuring device for an agricultural tractor includes detecting via a sensor arrangement a deflection of a bending bar caused by a tensile or shear force exerted at opposite bending bar ends of left and right lower links of a three-point hitch, identifying via a control unit, including a processor and memory, a tensile or shear force-free operating state of the three-point hitch, comparing via the control unit the deflection of the bending bar detected via the sensor arrangement with a specified limit value, and inferring via the control unit a maintenance requirement of the bending bar when the deflection of the bending bar exceeds the specified limit value.

### CROSS-REFERENCE TO RELATED APPLICATIONS

This application claims priority to European Patent Application No. 25177259.6, filed May 19, 2025, which is hereby incorporated by reference.

### FIELD OF THE DISCLOSURE

The disclosure relates to a method for determining the maintenance state of a tensile force measuring device for an agricultural tractor.

### BACKGROUND

Agricultural implements can be attached to a three point hitch of an agricultural tractor. Three point hitches can be controlled by a hitch control system which raises and lowers the hitch.

### SUMMARY

According to an aspect of the present disclosure, a method or system for determining a maintenance state of a tensile force measuring device for an agricultural tractor includes detecting via a sensor arrangement a deflection of a bending bar caused by a tensile or shear force exerted at opposite bending bar ends of left and right lower links of a three-point hitch, identifying via a control unit, including a processor and memory, a tensile or shear force-free operating state of the three-point hitch, comparing via the control unit the deflection of the bending bar detected via the sensor arrangement with a specified limit value, and inferring via the control unit a maintenance requirement of the bending bar when the deflection of the bending bar exceeds the specified limit value.

According to an aspect of the present disclosure, the control unit identifies the tensile or shear force-free operating state of the three-point hitch when the left and right lower links are in a lowered working position and when the agricultural tractor is stationary.

According to an aspect of the present disclosure, the control unit identifies the tensile or shear force-free operating state of the three-point hitch when the left and right lower links are in a lowered coupling position for attaching or removing an attachment and when the agricultural tractor is stationary.

According to an aspect of the present disclosure, the method includes inducing via the control unit an output of a maintenance instruction via a user interface when a maintenance requirement of the bending bar is identified.

According to an aspect of the present disclosure, the specified limit value includes a first level and a second level, and the control unit adapts the maintenance instruction depending on the whether the first level or the second level has been exceeded.

According to an aspect of the present disclosure, when the first level of the specified limit value has been exceeded, the control unit determines that recalibration of the tensile force measuring device is sufficient to compensate for the identified deformation of the bending bar.

According to an aspect of the present disclosure, when the second level of the specified limit value has been exceeded, the control unit determines the bending bar has to be replaced.

According to an aspect of the present disclosure, the method includes inferring via the control unit an overload-related deformation of the bending bar when the specified limit value has been repeatedly exceeded.

The above and other features will become apparent from the following detailed description and accompanying drawings.

### BRIEF DESCRIPTION OF THE DRAWINGS

The method according to the disclosure for determining the maintenance state of a tensile force measuring device for an agricultural tractor will be described in more detail below on the basis of the appended drawings. In the drawings:

FIG. 1 shows a schematic example embodiment of the method according to the disclosure in the form of a flowchart; and

FIGS. 2a-2b show an example tensile force measuring device for carrying out the method according to the disclosure as part of an agricultural tractor with a three-point hitch.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

The disclosure relates to a method for determining the maintenance state of a tensile force measuring device for an agricultural tractor, in which the tensile force measuring device comprises a bending bar and a sensor arrangement for detecting a deflection occurring at the bending bar, the deflection being caused by a tensile or shear force, exerted at opposite bending bar ends, of left and right lower links of a three-point hitch.

The deflection detected in this way makes it possible, starting from the mechanical properties of the bending bar which are assumed to be known, to reliably determine the tensile or shear forces occurring at the lower links of the three-point hitch during operation of a ground-penetrating attachment. This information is used, for example, in the course of draft control during plowing or the like.

Under normal circumstances, the bending bar springs back automatically into a neutral rest position in the force-free state. A tensile or shear force with the value zero is assigned to this neutral rest position by corresponding calibration of the tensile force measuring device. This is necessary because, due to tolerances, the bending bar usually also has a slight bend in its neutral rest position, this bend leading to a measurable deflection.

The occurrence of excessive bending stress can lead to the bending bar no longer being able to spring back completely into its neutral rest position. This can remain unidentified by the operator and lead to erroneous measurement results with regard to the extent of the actual tensile or shear forces. Causes of this kind of overload-related (permanent) deformation of the bending bar may be sudden effects of force when ground-penetrating attachments come into contact with rocks in the ground or the like.

In view of the above, the object of the present disclosure is that of specifying a method of the type mentioned at the outset which accordingly takes into account the occurrence of excessive bending stress on the bending bar.

This object is achieved by a method for determining the maintenance state of a tensile force measuring device for an agricultural tractor having the features of one or more embodiments disclosed herein.

In a method for determining the maintenance state of a tensile force measuring device for an agricultural tractor, the tensile force measuring device comprises a bending bar and a sensor arrangement for detecting a deflection occurring at the bending bar, the deflection being caused by a tensile or shear force, exerted at opposite bending bar ends, of left and right lower links of a three-point hitch. Here, a control unit (e.g., a controller including a processor and memory) compares the deflection of the bending bar detected by means of the sensor arrangement with a specified limit value when a tensile or shear force-free operating state of the three-point hitch is identified, in order to infer a maintenance requirement of the bending bar when the specified limit value is exceeded in terms of magnitude.

This procedure makes it possible to regularly check the maintenance requirement of the bending bar during ongoing operation of the agricultural tractor without having to visit a workshop for this purpose. Possible impairment of the function of the tensile force measuring device can thus be promptly identified and rectified, for example by recalibrating the tensile force measuring device or replacing the bending bar. The limit value is set in such a way that it is characteristic of overload-induced (permanent) deformation of the respectively used bending bar, depending on its mechanical properties, which are assumed to be known.

Here, the three-point hitch, located in the rear or front region of the agricultural tractor, usually has left and right lower links, which are articulated on a part of the chassis of the agricultural tractor in such a way that an attachment attached at associated coupling interfaces of the lower links can be selectively raised and lowered by means of a hydraulic lifting mechanism. Apart from the two lower links, also provided is a central upper link, which serves for guiding the attachment during raising and lowering and is hooked onto it by way of a further coupling interface. Here, the hydraulic lifting mechanism has left and right hydraulic cylinders, which can be used for pivoting left and right lifting arms which are connected to one another for conjoint rotation by way of a rigid shaft and at the free ends of which the two lower links are in turn articulated by way of respective lifting struts.

The hydraulic cylinders are actuated at the instigation of an actuating device designed as an electrically controllable valve arrangement. The actuating device has a first seat valve supplied with hydraulic fluid from a high-pressure pump of a hydraulic system for pressurizing associated piston chambers of the hydraulic cylinders and a second seat valve provided for depressurizing the piston chambers, the second seat valve leading into a hydraulic reservoir of the hydraulic system. In other words, the first seat valve serves for raising and the second seat valve for lowering the lower links of the three-point hitch.

Advantageous developments of the method according to the disclosure can be found in one or more embodiments disclosed herein.

For continuous diagnosis of the bending bar during operation of the agricultural tractor, provision can be made for the control unit to infer a tensile or shear force-free operating state of the three-point hitch when the lower links are (i) in a lowered working position and/or (ii) in a lowered coupling position for attaching or removing an attachment when the agricultural tractor is stationary. In both cases, it can be assumed with sufficient probability that the lower links are substantially free of tensile or shear forces, since any ground-penetrating attachment that may be present then rests idly on the ground. The control unit can easily identify whether the agricultural tractor is stationary by evaluating speed information from associated wheel speed sensors that is present on a CAN bus. The respective position of the lower links is determined, for example, by means of a travel sensor and communicated to the control unit in the form of corresponding position information via the CAN bus.

In addition, it is possible for the control unit to induce the output of a corresponding maintenance instruction via a user interface when a maintenance requirement of the bending bar is identified. The maintenance instruction can be output in the form of maintenance information on a display of the user interface or else transmitted to a server, to which a maintenance service has access, via a wireless interface as part of a remote diagnosis, the maintenance service then contacting the operator of the agricultural tractor. The user interface can be designed either as a graphical user interface (GUI) with a touch-sensitive display permanently installed in the agricultural tractor or else as a mobile terminal in the form of a smartphone or the like, the mobile terminal being connected for data exchange to the control unit via a wireless interface.

In addition, the limit value can be specified at least two levels, the output of the maintenance instruction being adapted by the control unit depending on the level of the specified limit value that has been exceeded. This makes it possible to differentiate the output of the maintenance instruction in terms of whether recalibration of the tensile force measuring device is sufficient to compensate for the identified deformation of the bending bar (first level), or whether the bending bar has to be completely replaced (second level).

In order to increase the reliability of the checking result, it is possible for the control unit to infer (permanent) overload-related deformation of the bending bar only when it establishes that the specified limit value has been repeatedly exceeded, i.e. for example exceeded several times in succession.

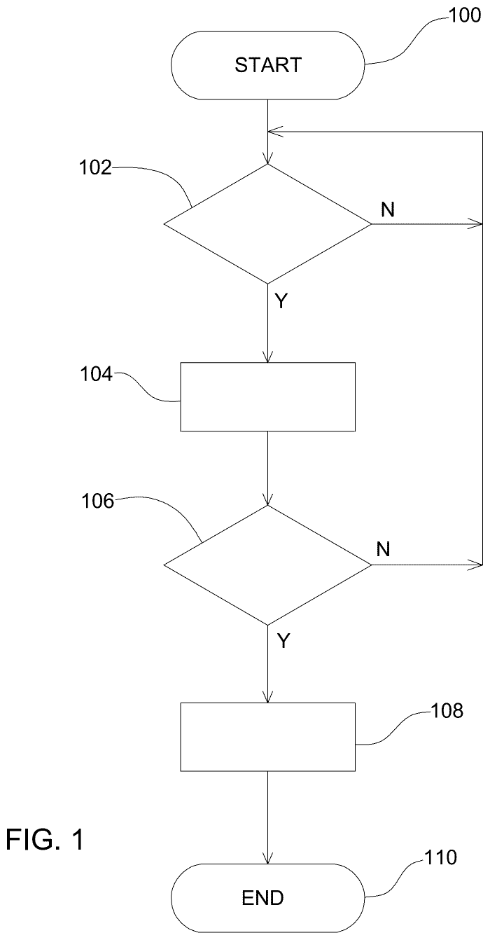

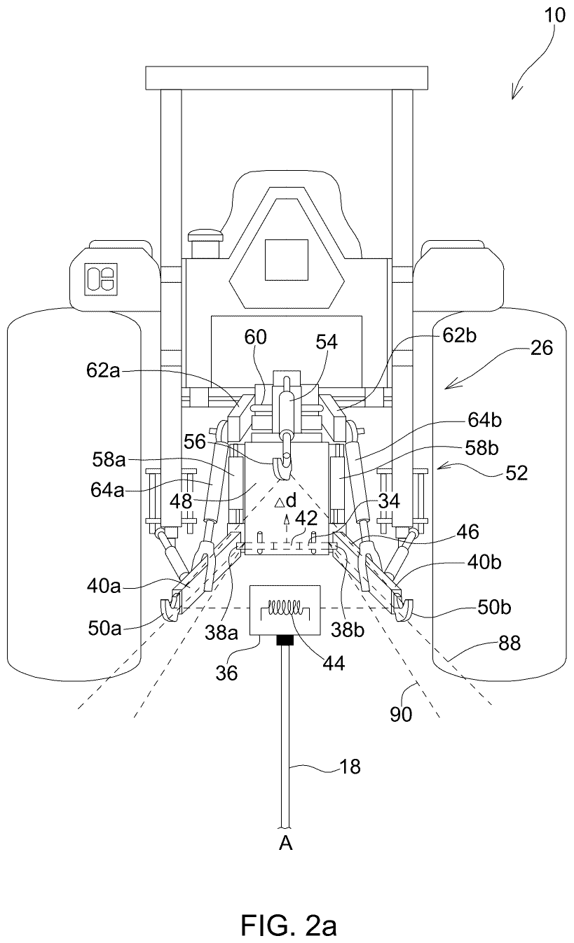

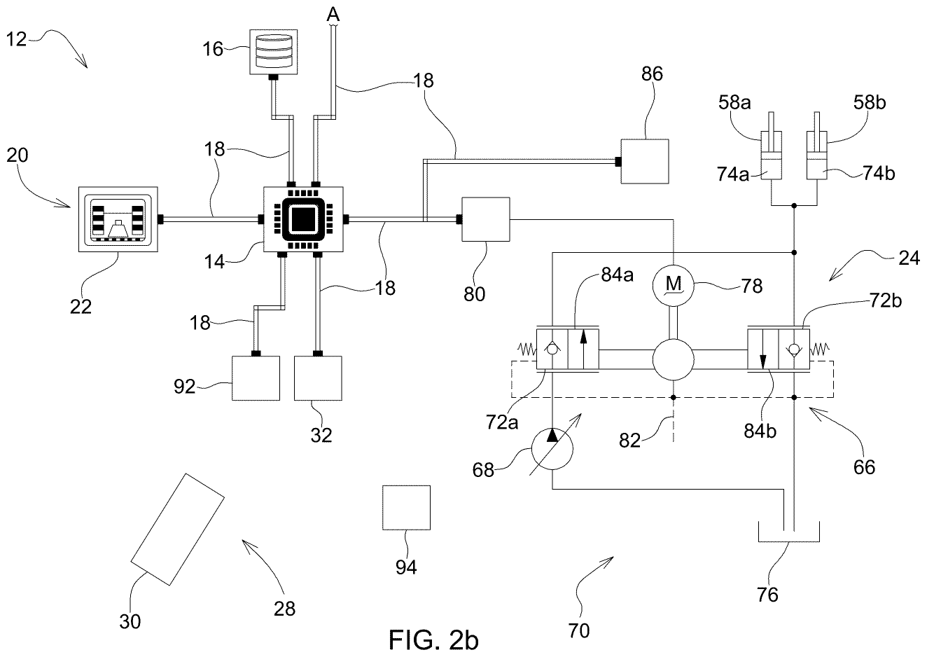

FIG. 1 shows a schematic example embodiment of the method according to the disclosure in the form of a flowchart, the tensile force measuring device according to FIGS. 2a-2b provided for carrying out the method being discussed first.

The tensile force measuring device 12 accommodated in an agricultural tractor 10 comprises a microprocessor-controlled control unit 14, an associated memory unit 16, a user interface 20 in the form of a touch-sensitive display 22 permanently installed in the agricultural tractor 10 as a graphical user interface (GUI) and communicating with the control unit 14 via a CAN bus 18, and an actuating device 24 for electrohydraulic control of a three-point hitch 26. A further user interface 28 is optionally provided, which is formed by a mobile terminal 30 in the form of a smartphone, the mobile terminal being connected for data exchange to the control unit 14 via a wireless interface 32.

Furthermore, there is a bending bar 34 and a sensor arrangement 36 for detecting a deflection Δd occurring at the bending bar 34, the deflection being caused by a tensile or shear force, exerted at opposite bending bar ends 38a, 38b, of left and right lower links 40a, 40b of the three-point hitch 26. For this purpose, the bending bar 34 has a central magnetized region 42 which, in order to provide corresponding deflection information, is detected by means of a Hall sensor 44 comprised by the sensor arrangement 36 with respect to a change in the field strength that occurs due to deflection.

The deflection Δd detected in this way makes it possible, starting from the mechanical properties of the bending bar 34 which are assumed to be known, to determine the tensile or shear forces occurring at the lower links 40a, 40b of the three-point hitch 26 during operation of a ground-penetrating attachment 46. This information is used, for example, in the course of draft control during plowing or the like.

As can be seen in FIGS. 2a-2b, the bending bar 34 is received by a chassis part of the agricultural tractor 10 formed by a differential housing 48, a respective one of the two lower links 40a, 40b being pivotably mounted at the bending bar ends 38a, 38b, so that the attachment 46 attached to associated coupling interfaces 50a, 50b of the lower links 40a, 40b can be selectively raised and lowered by means of a hydraulic lifting mechanism 52. Apart from the two hydraulically adjustable lower links 40a, 40b, also provided is a central upper link 54, which serves for guiding the attachment 46 during raising and lowering and is hooked onto it by way of a further coupling interface 56.

The hydraulic lifting mechanism 52 has left and right hydraulic cylinders 58a, 58b, which can be used for pivoting left and right lifting arms 62a, 62b which are connected to one another for conjoint rotation by way of a rigid shaft 60 and at the free ends of which the two lower links 40a, 40b are in turn articulated by way of respective lifting struts 64a, 64b.

The hydraulic cylinders 58a, 58b are actuated at the instigation of the actuating device 24 designed as an electrically controllable valve arrangement 66. The actuating device has a first seat valve 72a supplied with hydraulic fluid from a high-pressure pump 68 of a hydraulic system 70 for pressurizing associated piston chambers 74a, 74b of the hydraulic cylinders 58a, 58b and a second seat valve 72b provided for depressurizing the piston chambers 74a, 74b, the second seat valve 72b leading into a hydraulic reservoir 76 of the hydraulic system 70. Electrical control of the valve arrangement 66 is provided by an electromotive drive 78 which, at the instigation of the control unit 14 via a motor controller 80 as part of the actuating device 24, can deflect either the first or the second seat valve 72a, 72b to its open position 84a, 84b starting from a central blocking position 82 shown in FIGS. 2a-2b. In other words, the first seat valve 72a serves for raising and the second seat valve 72b for lowering the lower links 40a, 40b of the three-point hitch 26. A travel sensor 86 assigned to the lower links 40a, 40b feeds back the actuating movement performed by the lower links 40a, 40b to the control unit 14 via the CAN bus 18 by providing corresponding position information in order to regulate the control unit in a controlled manner.

With reference to the flowchart shown in FIG. 1, the method carried out by the control unit 14 and stored as corresponding program code in the memory unit 16 is initiated in a start step 100 when the agricultural tractor 10 is started up.

In a first step 102, the control unit 14 determines the current movement state of the agricultural tractor 10 by evaluating speed information from associated wheel speed sensors 92 (see FIGS. 2a-2b) that is present on the CAN bus 18. If the control unit 14 identifies that the agricultural tractor 10 is stationary, then a check is furthermore made on the basis of the position information provided by the travel sensor 86 as to whether the lower links 40a, 40b are at the same time (i) in a lowered working position 88 and/or (ii) in a (further) lowered coupling position 90 for attaching or removing the attachment 46. In both cases, it can be assumed with sufficient probability that the lower links 40a, 40b are substantially free of tensile or shear forces, since the ground-penetrating attachment 46 then rests idly on the ground. When such a tensile or shear force-free operating state of the three-point hitch 26 is identified, the method continues with a second step 104. Otherwise, the method returns to the first step 102 in order to be run through again.

In the second step 104, the control unit 14 determines, on the basis of the bending information provided by the sensor arrangement 36, whether a measurable deflection Δd of the bending bar 34 is present. If this is the case, the magnitude of the deflection is compared with a specified limit value Δd_max in a third step 106. The limit value Δd_max is set in such a way that it is characteristic of overload-induced (permanent) deformation of the respectively used bending bar 34, depending on its mechanical properties, which are assumed to be known. Consequently, when the specified limit value Δd_max is exceeded in terms of magnitude, the control unit 14 can infer a corresponding maintenance requirement of the bending bar 34, whereupon the method continues with a fourth step 108. Otherwise, in this case too, the method returns to the first step 102 in order to be run through again.

In the fourth step 108, the control unit 14 induces the output of a corresponding maintenance instruction via the user interface 20, 28. The maintenance instruction is output in the form of maintenance information on the display 22 of the user interface 20 or the further user interface 28 formed by the mobile terminal 30 or else transmitted to a server 94, to which a maintenance service has access, via the wireless interface 32 as part of a remote diagnosis, the maintenance service then contacting the operator of the agricultural tractor 10 (see FIGS. 2a-2b).

The limit value Δd_max is optionally specified at least two levels, the output of the maintenance instruction being adapted by the control unit 14 in the fourth step 108 depending on the level of the specified limit value Δd_max that has been exceeded. This serves the purpose of differentiating the output of the maintenance instruction in terms of whether recalibration of the tensile force measuring device 12 is sufficient to compensate for the identified deformation of the bending bar 34 (first level Δd_max_1), or whether the bending bar has to be completely replaced (second level Δd_max_2>Δd_max_1).

In order to increase the reliability of the checking result, provision is further made for the control unit 14 in the third step 106 to infer (permanent) overload-related deformation of the bending bar 34 only when it establishes that the specified limit value Δd_max has been repeatedly exceeded, i.e. exceeded several times in succession. This is the case, for example, after ten repetitions.

The fourth step 108 is followed by a final step 110, in which the method is ended.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for determining a maintenance state of a tensile force measuring device for an agricultural tractor, comprising:
detecting via a sensor arrangement a deflection of a bending bar caused by a tensile or shear force exerted at opposite bending bar ends of left and right lower links of a three-point hitch;
identifying via a control unit, including a processor and memory, a tensile or shear force-free operating state of the three-point hitch;
comparing via the control unit the deflection of the bending bar detected via the sensor arrangement with a specified limit value; and
inferring via the control unit a maintenance requirement of the bending bar when the deflection of the bending bar exceeds the specified limit value.

2. The method of claim 1, wherein the control unit identifies the tensile or shear force-free operating state of the three-point hitch when the left and right lower links are in a lowered working position and when the agricultural tractor is stationary.

3. The method of claim 1, wherein the control unit identifies the tensile or shear force-free operating state of the three-point hitch when the left and right lower links are in a lowered coupling position for attaching or removing an attachment and when the agricultural tractor is stationary.

4. The method of claim 1, further comprising:
inducing via the control unit an output of a maintenance instruction via a user interface when a maintenance requirement of the bending bar is identified.

5. The method of claim 4, wherein the specified limit value includes a first level and a second level, and the control unit adapts the maintenance instruction depending on the whether the first level or the second level has been exceeded.

6. The method of claim 5, wherein when the first level of the specified limit value has been exceeded, the control unit determines that recalibration of the tensile force measuring device is sufficient to compensate for the identified deformation of the bending bar.

7. The method of claim 6, wherein when the second level of the specified limit value has been exceeded, the control unit determines the bending bar has to be replaced.

8. The method of claim 1, further comprising:
inferring via the control unit an overload-related deformation of the bending bar when the specified limit value has been repeatedly exceeded.

9. A system for determining a maintenance state of a tensile force measuring device for an agricultural tractor, comprising:
a bending bar attached to left and right lower links of a three point hitch at opposite bending bar ends;
a sensor arrangement for detecting a deflection occurring at the bending bar of the left and right lower links of the three-point hitch, the deflection being caused by a tensile or shear force exerted at the opposite bending bar ends; and
a control unit configured to identify a tensile or shear force-free operating state of the three-point hitch, compare the deflection of the bending bar detected by the sensor arrangement with a specified limit value, and infer a maintenance requirement of the bending bar when the deflection of the bending bar exceeds the specified limit value.

10. The system of claim 9, wherein the control unit is configured to infer the tensile or shear force-free operating state of the three-point hitch when the left and right lower links are in a lowered working position and when the agricultural tractor is stationary.

11. The system of claim 9, wherein the control unit is configured to infer the tensile or shear force-free operating state of the three-point hitch when the left and right lower links are in a lowered coupling position for attaching or removing an attachment and when the agricultural tractor is stationary.

12. The system of claim 9, wherein the control unit is configured to induce the output of a maintenance instruction via a user interface when a maintenance requirement of the bending bar is identified.

13. The system of claim 12, wherein the specified limit value includes a first level and a second level, the control unit is configured to adapt the maintenance instruction depending on whether the first level or the second level has been exceeded.

14. The system of claim 13, wherein the control unit is configured to determine recalibration of the tensile force measuring device is sufficient to compensate for the identified deformation of the bending bar when the first level of the specified limit value has been exceeded.

15. The system of claim 14, wherein the control unit is configured to determine the bending bar has to be replaced when the second level of the specified limit value has been exceeded.

16. The system of claim 9, wherein the control unit is configured to infer an overload-related deformation of the bending bar when the specified limit value has been repeatedly exceeded.
